(19) United States
(12) Patent Application Publication
(10) Pub. No.: US 2007/0030385 A1
(43) Pub. Date: Feb. 8, 2007

(54) Advertising Panel Enclosure for Video Monitors

(76) Inventors: Christopher Tucker Crawford, Metairie, LA (US); Colin A. Davis, New Orleans, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/382,338

(22) Filed: May 9, 2006

Related U.S. Application Data
(60) Provisional application No. 60/679,820, filed on May 11, 2005.

(51) Int. Cl. H04N 11/00

(52) U.S. Cl. 348/468

(57) ABSTRACT

A static and electronic video display enclosure system, mountable on existing video monitors, or on newly designed monitors, including televisions, high definition plasma and liquid crystal displays (LCD), light emitting diode (LED), organic light emitting diode (OLED) displays, and other similar technologies for video broadcast and electronic graphics display, the system having a plurality of fixed internally illuminated ad panels positioned around the video display screen of the video monitor; a mounting bracket adaptable to the surface upon which the monitor is mounted, allowing mounting of the illuminated ad panel around the video screen for providing displays or messages that are apart from the video material appearing on the video screen; and wherein the electronic display portion of the enclosure is a programmable display utilizing light emitting diode technology or other similar technology to scroll or advertise messages.

### CROSS-REFERENCE TO RELATED APPLICATIONS

Priority of U.S. Provisional Patent Application Ser. No. 60/679,820, filed May 11, 2005, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to electronic signage. More particularly, the present invention relates to fixed advertising panels and electronic information and advertising displays mounted to video display systems such as televisions.

2. General Background of the Invention

A subtle comparison of an existing application is an electronic scoreboard used in stadiums and arenas (venues) for the sole purpose of keeping score and time for a sporting or associated event. The scoreboard, and in limited cases video replay systems used in larger professional venues, are usually surrounded by fixed advertising panels. These large format enclosures are built in pieces and are assembled as permanent fixtures for use in the one venue the scoreboard is designed for.

It is understood that when viewers (audience) watch a television or video production, an additional form of advertising other than the television or video advertising (commercials) is valuable to sponsors that desire additional advertising or informational impressions to a captive audience.

Therefore, it would be advantageous to provide an enclosure that provides additional means of product or service fixed and/or electronic advertising to the desired audience.

The following U.S. patents are incorporated herein by reference:

TABLE

| Patent No. | Title | Issue Date |
|---|---|---|
| 5,132,666 | Vehicle Mounted Electronic | 07/21/1992 |
| | Display System | |
| 6,271,814 | Dual Message Advertising Display | 08/07/2001 |
| | System | |
| 2002/0112237 | System and Method for Providing | 08/15/2002 |
| | an Interactive Display Interface | |
| | for Information Objects | |
| 2003/0001907 | Method and Apparatus for | 01/02/2003 |
| | Scrollable Cross-Point | |
| | Navigation in a User Interface | |
| 6,571,495 | Sign | 01/03/2003 |
| 6,700,602 | Subway TV Media System | 03/02/2004 |
| 6,737,983 | Display Board Having Illuminated | 05/18/2004 |
| | Elements and Method | |
| 2004/0107439 | Electronic Program Guide with | 06/03/2004 |
| | Support for Rich Program Content | |
| 2004/0186778 | Systems and Method for Selecting | 09/23/2004 |
| | Advertisements to be Provided to | |
| | Users Via a Communication Network | |
| 2004/0189710 | Technique for Displaying a | 09/30/2004 |
| | Window in a Computer Screen | |
| 2005/0005308 | Method and Apparatus for | 01/06/2005 |
| | Recording and Replaying Sports | |
| | Broadcasts | |
| 2005/0007501 | Visual Management System | 01/13/2005 |

### BRIEF SUMMARY OF THE INVENTION

The system of the present invention solves the problems in the art in a simple and straightforward manner. What is provided is a static and electronic video display enclosure system, mountable on existing video monitors, or on newly designed monitors, including televisions, high definition plasma and liquid crystal displays (LCD), light emitting diode (LED), organic light emitting diode (OLED) displays, and other similar technologies for video broadcast and electronic graphics display, the system having a plurality of fixed internally illuminated ad panels positioned around the video display screen of the video monitor; a mounting bracket adaptable to the surface upon which the monitor is mounted, allowing mounting of the illuminated ad panel around the video screen for providing displays or messages that are apart from the video material appearing on the video screen; and wherein the electronic display portion of the enclosure is a programmable display utilizing light emitting diode technology or other similar technology to scroll or advertise messages. Generally speaking, the invention features fixed information or advertising panels combined with programmable electronic information or advertising displays to be affixed to new or existing video displays such as televisions. For purposes of this description, “video displays” is meant to include all portable video monitors such as televisions, high definition televisions, flat panel monitors including plasma and liquid crystal displays (LCD), light emitting diode (LED), organic light emitting diode (OLED) displays, and other similar technologies for video broadcast and electronic graphics display.

Therefore, it is a principal object of the present invention to provide an advertising display system for video monitors, including an electronic display portion of the enclosure which is a programmable display utilizing light emitting diode technology or other similar technology to scroll or advertise messages.

It is a further object of the present invention to provide an advertising display system for video monitors wherein the electronic display is also designed to be connected via a data cable or wireless receiver to ticker services such as a sports ticker total sports board or news wire, allowing the electronic display to serve as a separate informational source.

It is a further object of the present invention to provide an advertising display system for video monitors having a display enclosure around the monitor to serve as a separate enclosure to the video display such as a television.

It is a further object of the present invention to provide an advertising display system for video monitors wherein the enclosure is capable of being fitted or attached to existing makes and models (different manufacturers) as long as the physical size of the video display is similar to other makes and models, such as a 30″ LCD Flat Screen High Definition Television manufactured by different companies.

It is a further object of the present invention to provide an advertising display system for video monitors which is portable and configured for continued maintenance and updating of sponsor information, logos, and copy for various advertising campaigns and uses which in some cases require updating.

It is a further object of the present invention to provide an advertising display system for video monitors for the enclosure to be detachable for the purposes of transporting the enclosure along with its television counterpart.

It is a further object of the present invention to provide an advertising display system for video monitors wherein the enclosure has the ability to travel in one piece or further disassembled for more compact transport such as airfreight, allowing the enclosure to be more user friendly for situations where portability for applications, such as traveling conventions or trade shows, is desired.

There is provided an Information Disclosure Statement herewith which includes prior art which may be pertinent to the present invention.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates an exploded view of a standard flat screen monitor mounted onto its typical mounting bracket;

FIG. 2 illustrates a flat screen video monitor in exploded view with the ad panel display system, without mounting brackets;

FIG. 3 illustrates the preferred embodiment of the assembled ad panel display system;

FIG. 4 illustrates a view of the video mounting bracket and the ad panel enclosure display bracket mounted onto a wall;

FIG. 5A illustrates an exploded view of the assembled ad panel display system being assembled onto the mounting bracket for final assembly;

FIG. 5B illustrates the rear view of the composite ad panel display system and monitor with mounting brackets;

FIG. 6 illustrates an exploded view of the ad panel display system and the enclosure;

FIG. 7 illustrates the preferred embodiment of the ad panel enclosure display displaying a representative ads around the video monitor screen;

FIGS. 8A through 8G illustrate various arrangements of the ad panel displays surrounding the four sides of a flat screen video monitor;

FIG. 9 illustrates a cross sectional view of the modular panel illustrated in FIG. 9 showing an LED contained therein for lighting the face of the component;

FIG. 10 illustrates a modular panel that can be withdrawn from a display by means of a flexible trim piece and a second panel being inserted therein; and

FIG. 11 illustrates an additional embodiment of the composite ad panel/video monitor system mounted on a pedestal.

### DETAILED DESCRIPTION OF THE INVENTION

Before a discussion of the Figures, it should be made clear that the multiple static and electronic display enclosure may be assembled by the video monitor manufacturer (sold as an original permanent part of the video monitor) or as an after market ad panel enclosure to be added to existing video monitors with mounting combinations.

The overall mission of the ad panel enclosure system is to become the primary video display advertising enclosure platform for the portable and fixed advertising video display market. The system will enable portable and fixed video display systems to increase viewer awareness of ad panels, sponsor driven advertising and brand awareness by taking advantage of existing viewers. The ad panel Enclosure is a relatively simple and readily adaptable ad panel/sponsor enclosure that will enhance any video displays capability and revenue generating potential.

This is achieved by

Adapting the Ad Panel Enclosure to new or existing video display systems (monitors, televisions, etc.) and having the capability to attach to and/or manufactured as original equipment under license by many different name brands of video display systems. The system will utilize extremely low power LED lighting strips to internally illuminate the translucent sponsor/ad panels for maximum viewability, thus not requiring additional power supplies. (will be able to use existing power supplies from manufacturer, with manufacturers input. It is projected that the Ad Panel Enclosure will quickly establish a niche market for specialized advertising displays to be utilized for numerous applications. The Ad Panel enclosure is a cost effective method to enhance any advertising or corporate awareness program already utilizing video monitor, television or flat panel displays.

It is very obvious to pursue the retail consumer, travel, and sports fan market. The sale of flat panel plasma and LCD displays (traditional 4:3 format and the more accepted 16:9 HDTV format) represent a significant retail consumer market. The commercial market is still developing and not fully realized. Manufactures are all actively engaged in the marketing and manufacturing of flat panel displays to/for retail consumers and now just recently the evolving commercial market. The most obvious and profitable commercial applications for the Ad Panel Enclosure are Convention displays, Retail displays, Shopping Malls, Arenas, Stadiums, Sports bars/nightclubs, Restaurants, Elevators, Restrooms, Airports, Train, Metro Stations, Airplanes, buses, trains, taxis (back of seat) Menu Boards of fast food outlets, External outdoor displays (small billboards), Digital Kiosks, Grocery Stores, Super Markets and Personal advertising systems (www.pixman.com. etc.)

The Ad Panel Enclosure will provide a much needed niche marketing advantage to existing commercial users of flat panel/Cathode Ray Tube video display technologies. The enclosure will provide an additional means of “fixed” brand/sponsor advertising on a constantly moving and changing video message. The viewers will in essence see not only the moving video display, but also peripherally view the static “fixed” logo or message inserted in the internally illuminated “backlit” sponsor/ad panels surrounding the video display.

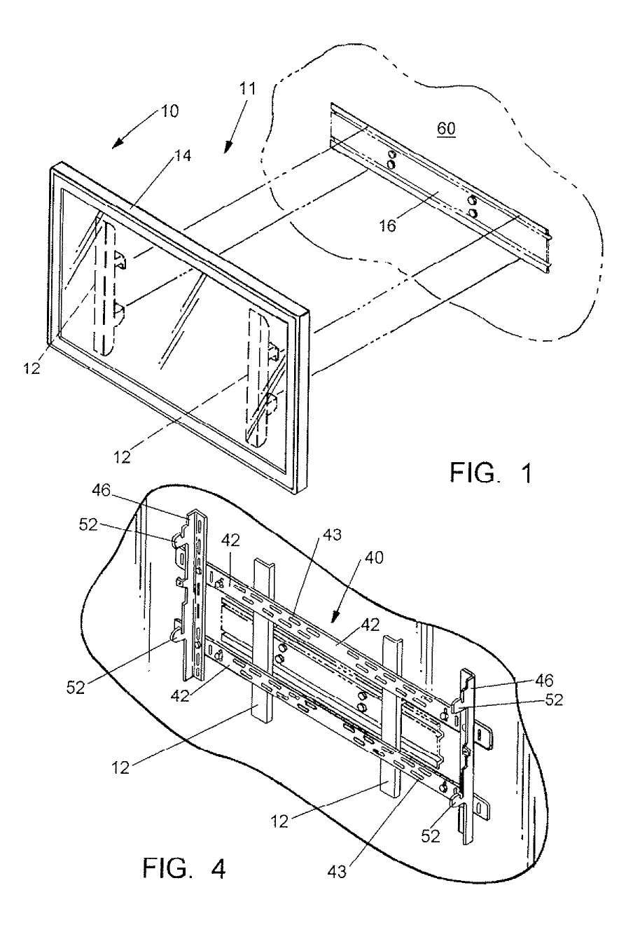

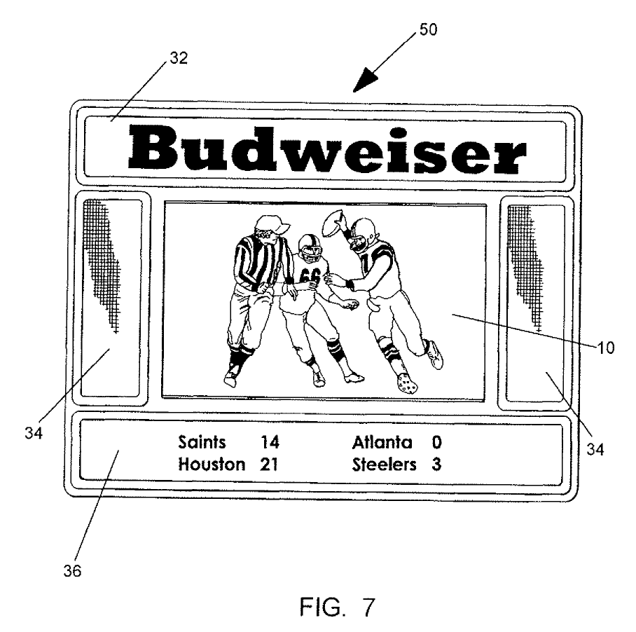

Reference is now made to FIGS. 1-10 which illustrate the preferred embodiment of the apparatus of the present invention as illustrated in assembled view in FIG. 7, in particular. Turning first to FIG. 1, there is illustrated a standard flat screen video monitor 10, which may be defined as a video display including all portable video monitors such as televisions, high definition plasma and liquid crystal displays (LCD), light emitting diode (LED), organic light emitting diode (OLED), displays, and other similar technologies for video broadcast and electronic graphics display. As seen in FIG. 1, the monitor 10 would have a standard mounting bracket means 11, which includes a pair of vertical mounting arms 12 attached to the rear surface 14 of the monitor 10. The pair of brackets 12 would be secured to a vertical surface 60, such as a wall, via a vertical surface bracket 16, and in that manner the flat screen monitor 10 could be placed on a wall of the like when in use.

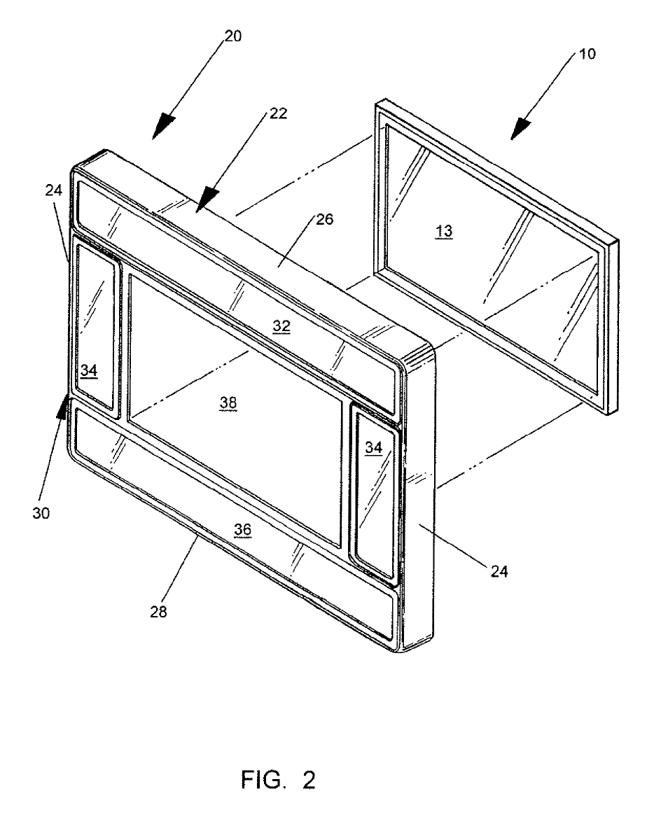

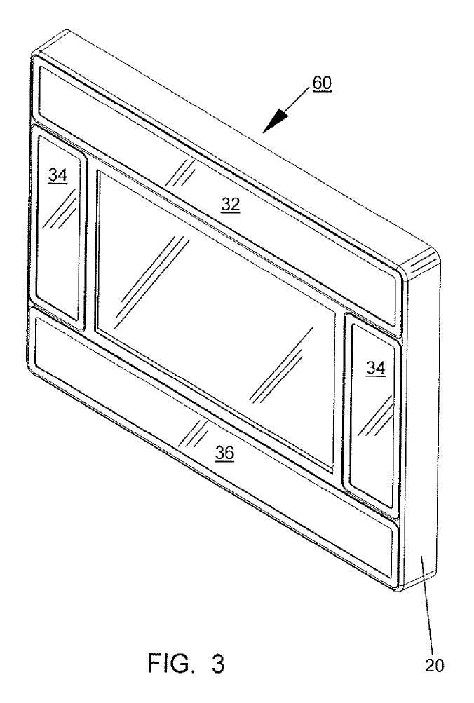

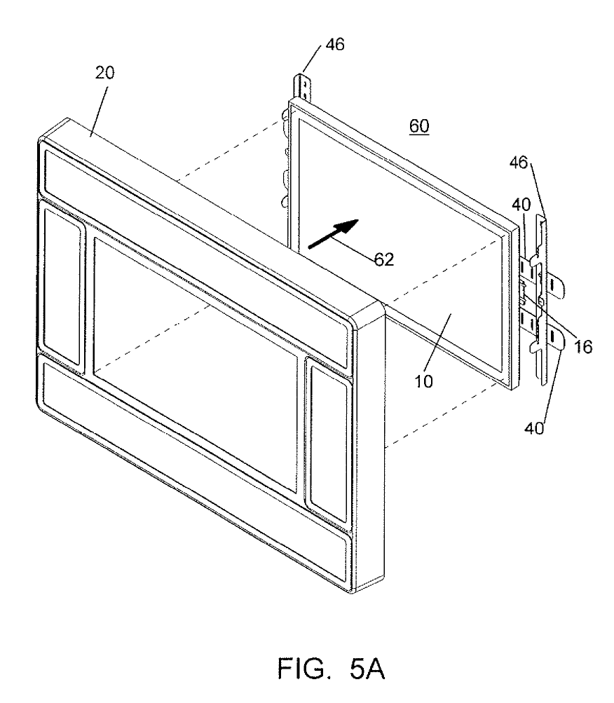

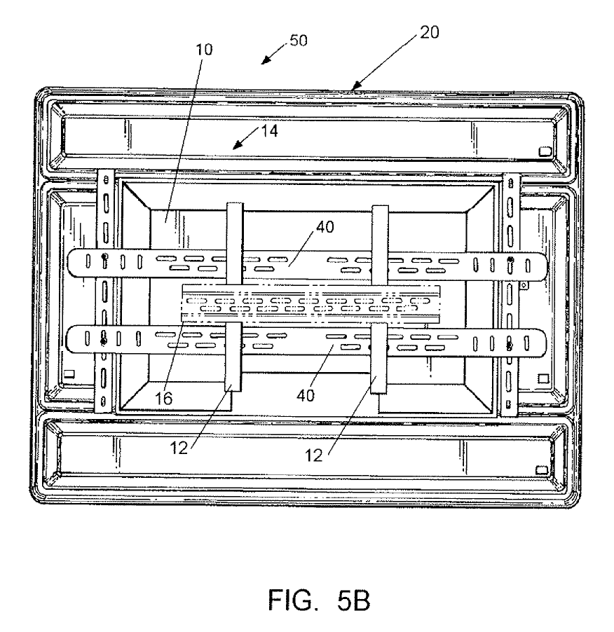

In FIG. 2, there is illustrated the ad panel display system 20 of the present invention ready to be fitted onto a flat screen monitor 10. The mounting brackets are not depicted in this view, but will be illustrated and discussed in FIG. 5A. In its preferred embodiment, the system 20 would include a three dimensional enclosure 22 having a pair of vertical sidewalls 24, an upper wall 26 and a lower surface or wall 28. The enclosure 22 would include a plurality of front ad panels 30 which would include front upper ad panel 32, front side ad panels 34, and a front lower ad panel 36. This would define the entire enclosure 22. As illustrated in FIG. 2, the enclosure 22 would have an opening 38 in its center which would be sized as to accommodate a typical monitor 10, having a screen 13, also illustrated in FIG. 2, and as was discussed and illustrated in FIG. 1. When the display system 20 is assembled, the enclosure 22 would be fitted onto monitor 10 as is illustrated in the complete assembly in FIG. 3. The monitor 10 assembled with the display system 20 is defined as the composite monitor/ad panel display system 50.

As was discussed earlier in relation to FIG. 1, a typical video monitor 10 would be mounted onto its bracket means 11, which includes brackets 12 and 16 as illustrated in FIG. 1, and would be placed on a vertical surface 60. When the display system 20 is fitted onto monitor 10, as seen in FIG. 3, the display system 20 would likewise be required to have a mounting composite mounting bracket system that would allow it to be positioned around monitor 10 without monitor 10 having to support the weight of the system 20 when it is fully assembled. Therefore, turning to FIG. 4, there is illustrated the composite mounting bracket 40 that would be utilized in conjunction with the mounting bracket 12 of monitor 10. As illustrated in FIG. 4, the mounting bracket 40 would include a pair of horizontal mounting members 42 which would be secured to the rear surface 14 of monitor 10. Next, there would be provided a pair of vertical mounting arms 46 mounted onto the mounting members 42, each of which would include a plurality of teeth 52 which would extend outward from the wall 60 on the vertical mounting arms 46. As illustrated in FIG. 4, the teeth 52 which would be so spaced apart so as to allow the monitor 10 to fit intermediate the two vertical mounting arms 46, yet when the system 20 is placed thereupon, the system 20 would be supported by the teeth 52 and would allow it to be supported in the same manner as the video monitor 10 as seen in the composite view in FIG. 3. As seen in FIG. 4, the horizontal members 42 include a plurality of openings 43, which would allow the vertical arms 46 to be spaced in varying distances apart depending on the width of a particular monitor 10 upon which the system 20 is mounted.

For example, as seen further in FIG. 5A, the mounting bracket 40 is seen secured to the monitor 10, and the monitor 10 secured to the surface 60. There is further illustrated the ad panel display system 20. At this point, the ad panel display system 20 would be slid in the direction of arrow 62 and would be supported onto the composite mounting brackets 40, as was illustrated in FIG. 3. FIG. 5B illustrates a rear view of the ad panel display system 20, enclosing monitor 10, supported by the composite bracket 40, while the composite unit 50 is supported by the monitor bracket means 11. Once the system 50 is in place, then the composite unit 50 is ready to operate with the video monitor 10 being utilized in its normal fashion, and the ad panel 20 with its plurality of ad panels 32, 34 and 36 utilized to display various types of ads or the like during use.

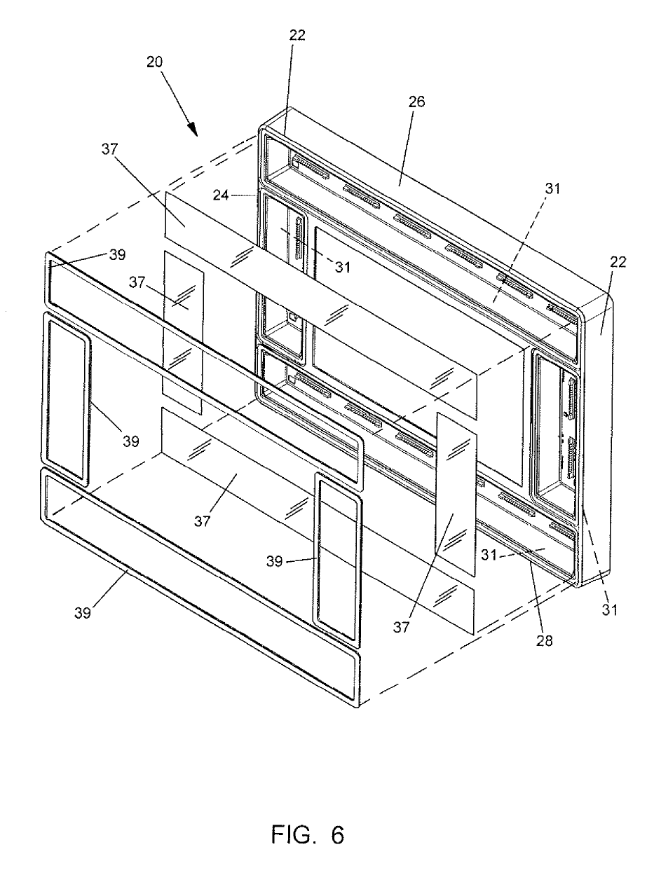

In discussing the construction of the ad system 20, and the enclosure 22, reference is made to FIG. 6. In that figure, there is seen an exploded view of the ad panel display system 20 which, as was discussed earlier, includes the enclosure 22, having the vertical sidewalls 22, 24 and the upper wall 26 and lower wall 28. The enclosure 22 would include a plurality of openings or compartments 31 along its border so as to accommodate the ad panels which would display the messages to the users of the system. These messages may be in the form of LEDs or simply lighted messages or unlighted word messages or pictorial messages that would be placed in the various openings 31. There would then be inserted a panel plate 37 over each of the openings which would allow one to view various messages being displayed. Once the various plates 37 in place, the four plates would define the face of the top panel 32, side panels 34, and bottom panel 36 of the ad display system 20, upon which messages would be displayed, as will be discussed further. At that point, the final outer frames 39 would then be placed onto the unit which would then form the composite unit 20 as illustrated. It should be made clear once more that the system 20 is able to display messages independent of the images being displayed on monitor 10. Likewise any electrical lighting or the like components within system 20 are powered independently of the monitor 10, either through AC current or battery power.

Turning now to FIG. 7, one sees what could be a typical advertisement utilized in the composite unit 50, which, in this case, would include a sport activity, such as football being shown on the face of the monitor 10, while there is included in the upper ad panel 32, the term “Budweiser” (which is a registered trademark of Budweiser Corporation), while on the bottom panel 36 there is seen a sports score for various types of games. Simultaneously, the pair of side panels 34 are left blank, or they could have other promotional statements or logos or pictures or words displayed thereon. Again, it should be made clear that as seen in FIG. 7, the term “Budweiser” may be done in lights, or the word may be written onto a flat surface in the panel 32 as would be the other panels 34 and 36 depending on what a particular customer would want to utilize. Also, each of the top panel 32, bottom panel 36 and side panels 34 may each display lighted or unlighted images independently of one another in this process.

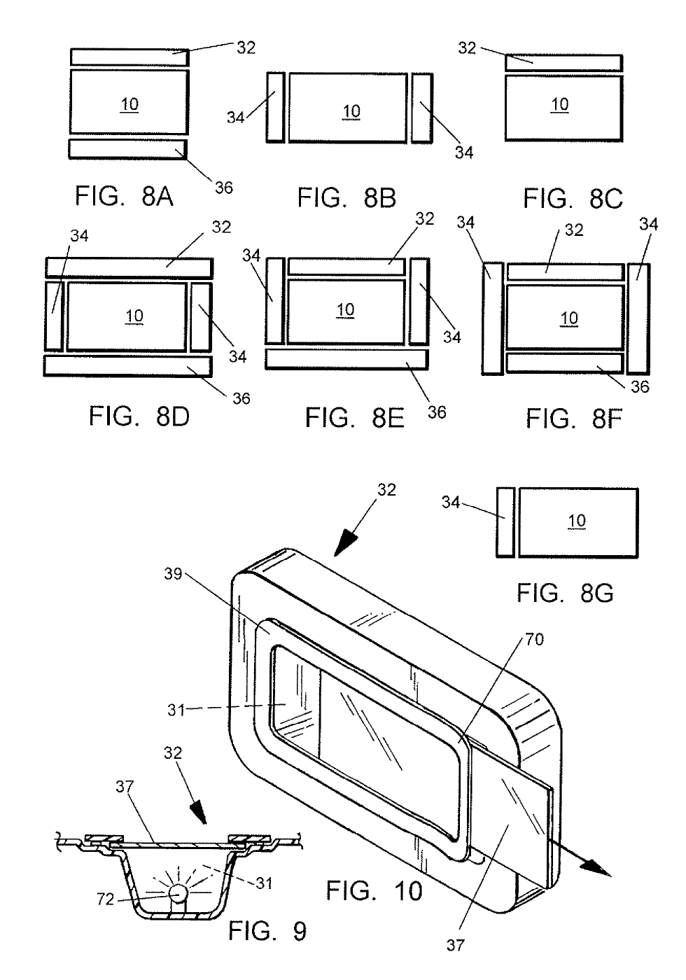

Turning now to FIGS. 8A-8G, there is illustrated a typical monitor 10 in each of the figures and the ad panels 32, 34 and 36 displayed in various embodiments of the system 20. For example, in FIG. 8A there is seen the top panel 32, lower panel 36 with no side panels 34. In FIG. 8B there is illustrated only the side panels 34 without a top or bottom panel 33, 36, respectively. In FIG. 8C there is illustrated a top panel 32 with the monitor 10, with no other panels shown as part of the system 20. In FIG. 8D there is illustrated all four panels, with the top panel 23 and the bottom panel 36 extending across the entire width of the monitor, while side panels 34 are seen slightly truncated in their use. Whereas, in FIG. 8E the top panel 32 is the width of the monitor 10, the lower panel 36 extends beyond the width of the monitor 10, while the side panels 34 appear to be resting on lower panel 36. In FIG. 8F there is seen the view where the side panels 34 extend the entire height of the unit 50 while the top panel 32 and lower panel 36 cover only the width of the monitor 10. Finally, in 8 G there is seen simply one side panel 34 next to the monitor 10 without any of the other panels in place. These are views of the manner in which the panels could be arranged around the video monitor 10 but are no means are exhaustive. These are simply illustrative of the various options that this unit allows.

Turning now to FIGS. 9 and 10, it is foreseen that the ad panels could be more modular in nature. For example, there may be included an ad panel 32, as seen in the FIG. 10, where there is seen the opening 31 as was discussed earlier and with a panel plate 37, which may have a message or the like on its face. Rather than have to take the panel apart in order to place the panel plate 37 in place, one would simply lift the edge 70 of the outer face 39 and slide the ad panel 32 out and replace it with a new panel plate 37. FIG. 9 illustrates a cross section view of space 31, of the ad panel 32, illustrated in FIG. 10, where there would be included a series of LEDs 72, or the like, illuminating the panel plate 37 after it has been replaced in the ad panel display system 20.

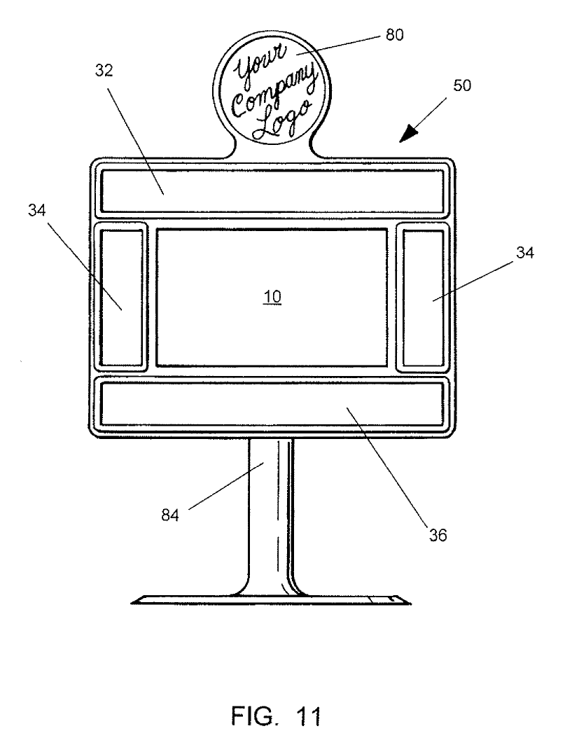

FIG. 11 illustrates a modified embodiment of the composite ad panel display system 50 as it would be arranged around the monitor 10. In this case, there is seen the two side panels 34 and lower panel 36 in rectangular shape, whereas the upper panel 32 has an unusual shape which allows a greater face 80. This face 80 would allow a company or other organization to place its name or logo in that larger space so that it would be an advertisement of the company name or logo while one was viewing the video monitor 10 around which the ad panel system 20 is assembled. This particular embodiment of system 50 is illustrated being supported by on a pedestal 84, although it also may be supported on a wall 60, or suspended from the ceiling. It is foreseen of course that there could be other word or like displays on side panels 34 and lower panel 36 as would be requested by the customer.

As stated earlier, the video display system includes all portable video monitors such as televisions, high definition plasma and liquid crystal displays (LCD), light emitting diode (LED), organic light emitting diode (OLED) displays, and other similar technologies for video broadcast and electronic graphics display. The monitor would be provided with a plurality of panels, which may include one or more side panels, a top panel, and a bottom panel, to define a perimeter of ad panels, wherein advertising messages could be provided through electronic or other means, as discussed herein. In addition, the ad panels may be provided as a one piece ad panel display unit having an opening wherein the monitor, such as a high definition television, may be placed. There could be provided a LED programmable display along the bottom panel 20, or for that matter, through any of the other panels which surround the monitor. Again, the display unit could be provided by the manufacturer as a permanent part of the monitor, or it could be retrofitted onto existing monitors of any size and dimension.

The following is a list of parts and materials suitable for use in the present invention.

PARTS LIST

| Part Number | Description |
|---|---|
| 10 | video monitor |
| 11 | mounting bracket means |
| 12 | vertical mounting arms |
| 13 | screen |
| 14 | rear surface |
| 16 | surface bracket |
| 20 | ad panel display system |
| 22 | three dimensional enclosure |
| 24 | vertical sidewalls |
| 26 | upper wall |
| 28 | lower wall |
| 30 | front ad panels |
| 31 | openings |
| 32 | upper ad panel |
| 34 | side ad panels |
| 36 | lower ad panels |
| 37 | panel plate |
| 38 | opening |
| 39 | outer frames |
| 40 | composite mounting bracket |
| 42 | horizontal mounting members |
| 43 | openings |
| 44 | screws |
| 46 | vertical mounting arms |
| 48 | outer extending portion |
| 50 | composite monitor/ad panel display |
| | system |
| 52 | teeth |
| 60 | vertical surface |
| 62 | arrow |
| 70 | edge |
| 72 | LED |
| 80 | face |
| 84 | pedestal |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A video display enclosure system, comprising:
a. a video portion having a video screen;
b. an ad display portion, comprising an enclosure assembled around the video portion so as to provide a lighted or unlighted display around at least portions of the perimeter of the video screen which is different from the image on the screen.

2. The apparatus in claim 1, wherein the video portion comprises a portable video monitor such as televisions, high definition plasma and liquid crystal displays (LCD), light emitting diode (LED), organic light emitting diode (OLED) displays, and other similar technologies for video broadcast and electronic graphics display.

3. The system in claim 1, wherein the ad display portion defines a programmable display utilizing light emitting diode technology to scroll or advertise messages.

4. The system in claim 1, wherein the ad display portion provides a means to be connected via a data cable or wireless receiver to ticker services, allowing the ad display portion to serve as a separate informational source complementing the primary video program displayed on the video portion.

5. The system in claim 1, wherein the video portion is mounted to a vertical surface and the ad display portion is mounted to the vertical surface as a full or partial enclosure to the video portion.

6. A static and electronic video display enclosure system, mountable on an existing video monitor mounted on a vertical surface, the system comprising:
a. at least one fixed internally illuminated ad panel positioned around a screen of the video monitor;
b. a mounting bracket adaptable to the vertical surface for mounting the illuminated ad panel adjacent the video screen for providing displays or messages that are apart from the video material appearing on the video screen.

7. The system in claim 6, wherein the video monitor comprises all portable monitors, including televisions, high definition plasma and liquid crystal displays (LCD), light emitting diode (LED), organic light emitting diode (OLED) displays, and other similar technologies for video broadcast and electronic graphics display.

8. The system in claim 6, wherein the electronic display portion of the enclosure is a programmable display utilizing light emitting diode technology or other similar technology to scroll or advertise messages.

9. The system in claim 6, wherein there is provided a plurality of ad panels surrounding the video screen for displaying various displays and messages apart from the video material on the video screen.

10. A multiple static and electronic video display enclosure system, comprising:
a. a flat screen video monitor mounted to a vertical surface, such as a wall;
b. an ad panel display portion, including at least upper, lower and side ad panels utilizing light emitting diode technology for providing scroll or advertising messages on each of the ad panels, apart from what is being shown on the screen of the video monitor; and
c. a bracket system for supporting the ad display portion as a single unit around the video monitor so that the video monitor screen is surrounded by the ad panels, but the video monitor is not supporting the ad display portion.

11. The system in claim 10, wherein the ad display portion is mountable onto already existing flat screen video monitors.

12. The system in claim 10, wherein the, video monitor includes all portable video monitors such as televisions, high definition plasma and liquid crystal displays (LCD), light emitting diode (LED), organic light emitting diode (OLED) displays, and other similar technologies for video broadcast and electronic graphics display.

13. The system in claim 10, wherein the electronic display portion of the enclosure is a programmable display utilizing light emitting diode technology or other similar technology to scroll or advertise messages.

14. The system in claim 10, wherein the electronic display is also designed to be connected via a data cable or wireless receiver services for allowing the electronic display to serve as a separate informational source complementing the primary video program displayed on the video display or television.

15. A method of providing ad messages surrounding a video screen of a video monitor, separate from the images appearing on the screen of the video monitor, comprising the following steps:
a. providing a portable video monitor, such as a television, high definition plasma and liquid crystal display (LCD), light emitting diode (LED), organic light emitting diode (OLED) display, and other similar technologies for video broadcast and electronic graphics display;
b. mounting the video monitor onto a vertical surface, such as a wall;
c. assembling an ad display portion, having a top, bottom and side wall ad panels, each panel having the capability to provide a programmable display utilizing light emitting diode technology or other similar technology to scroll or advertise messages, and having a central opening of the same dimensions as the screen of the video monitor;
d. providing a mounting bracket to mount the ad display portion onto the vertical surface when the ad display portion is positioned onto and around the video monitor.

16. The method in claim 15, wherein the ad display portion includes one or more display panels as part of the assembly.

17. The method in claim 15, wherein the ad display portion includes interchangeable panel faces which can be interchanged without removing the ad display portion from around the video monitor.

18. The method in claim 15, wherein there is provided at least one ad panel having the capability of being shaped in the shape of a corporate logo as part of the assembly.

19. The method in claim 15, wherein the video monitor includes flat screen monitors or standard video monitors positionable on a flat surface, suspended from the ceiling on a mounting pole, supported on a standard placed on the floor.

20. The method in claim 15, wherein the ad display portion includes at least one ad panel positioned along the top wall, the bottom wall, or either side wall of the video monitor.
